(19) United States
(12) Patent Application Publication
(10) Pub. No.: US 2025/0154659 A1
(43) Pub. Date: May 15, 2025

(54) METAL MEMBER AND MANUFACTURING METHOD THEREFOR, ETCHING SOLUTION, AND METAL-RESIN COMPLEX AND MANUFACTURING METHOD FOR METAL-RESIN COMPLEX

(71) Applicants: MITSUI CHEMICALS, INC., Chuo-ku, Tokyo (JP); HUIZHOU JIANUOTE TECHNOLOGY CO., LTD, Huizhou, Guangdong (CN)

(72) Inventors: Daiki SUMITA, Sodegaura-shi (JP); Haibing LU, Huicheng District Huizhou, Gua (CN)

(73) Assignees: MITSUI CHEMICALS, INC., Chuo-ku, Tokyo (JP); HUIZHOU JIANUOTE TECHNOLOGY CO., LTD, Huizhou, Guangdong (CN)

(21) Appl. No.: 18/856,873

(22) PCT Filed: Apr. 13, 2023
(86) PCT No.: PCT/CN2023/088201

§ 371 Date: Oct. 14, 2024

(30) Foreign Application Priority Data
Apr. 15, 2022 (CN) 202210397468.3

(51) Int. Cl. C23F 1/18; B29C 45/14; B29K 705/10; B32B 15/08; B32B 15/20

(52) U.S. Cl. CPC C23F 1/18; B32B 15/08; B32B 15/20; B29C 45/14311; B29C 2045/14868; B29K 2705/10

(57) ABSTRACT

The present invention relates to a metal member and a manufacturing method therefor, an etching solution, and a metal-resin complex and a manufacturing method for the metal-resin complex. The metal member has a surface in which values of L, a and b in CIE1976 (L*a*b*) color space satisfy at least one of equation (1) (b≥16) or equation (2) (L≥2.336×8-2.0536).

### TECHNICAL FIELD

The present disclosure relates to a metal member and a manufacturing method for a metal member, an etching solution, and a metal-resin complex and a manufacturing method for a metal-resin complex.

### BACKGROUND ART

Metal-resin complexes exhibit features derived from a metal member (such as electrical conductivity or thermal conductivity) combined with features derived from a resin member (such as electrical insulation), and are used for various purposes such as components for vehicles, for example. In some cases of manufacturing a metal-resin complex, a metal member having a roughened surface is used in order to increase a joining strength with respect to the metal member. Such a metal member having a roughened surface is described in Patent Document 1, for example.

### PRIOR ART DOCUMENT

### Patent Document

Patent Document 1: Japanese Patent No. 6387543

### SUMMARY OF THE INVENTION

### Problem to be Solved by the Invention

A problem to be solved by an embodiment of the present disclosure is to provide a metal member that exhibits excellent joining strength with respect to a resin member.

A problem to be solved by another embodiment of the present disclosure is to provide a manufacturing method for the metal member.

A problem to be solved by another embodiment of the present disclosure is to provide an etching solution used for the manufacture of the metal member.

A problem to be solved by another embodiment of the present disclosure is to provide a metal-resin complex in which a resin member is joined to the metal member.

A problem to be solved by another embodiment of the present disclosure is to provide a manufacturing method for the metal-resin complex.

### Means for Solving the Problem

The present disclosure includes the following embodiments.
<1>A metal member, having a surface in which values of L, a and b in CIE 1976 (L*a*b*) color space satisfy at least one of the following Formula (1) or Formula (2):
   b≥16 (1); or
   L≥2.336×a-2.0536 (2).
<2> The metal member according to <1>, wherein, in the surface, values of L and a in CIE 1976 (L*a*b*) color space satisfy the Formula (2) and the following Formula (3): L≤2.336×a+14.649 (3).
<3> The metal member according to <2>, wherein, in the surface, a value of a in CIE 1976 (L*a*b*) color space satisfies the following Formula (4): 25≥a≥10 (4).
<4> The metal member according to any one of <1> to <3>, comprising at least one of copper or copper alloy.
<5> The metal member according to any one of <1> to <4>, comprising a nitrogen-containing heteroaromatic compound that is disposed at at least a portion of the surface.
<6> An etching solution, comprising an amine compound, a nitrogen-containing heteroaromatic compound, a hydrogen peroxide, and an inorganic acid.
<7> The etching solution according to <6>, wherein a content of the amine compound with respect to a total mass of the etching solution is from 0.0001% by mass to 5% by mass.
<8> The etching solution according to <6>, wherein a content of the nitrogen-containing heteroaromatic compound with respect to a total mass of the etching solution is from 0.01% by mass to 2.0% by mass.
<9> The etching solution according to <6>, wherein a content of the hydrogen peroxide with respect to a total mass of the etching solution is from 0.5% by mass to 7% by mass.
<10> The etching solution according to <6>, wherein a content of the inorganic acid with respect to a total mass of the etching solution is from 5% by mass to 20% by mass.
<11> The etching solution according to <6>, wherein the amine compound is an amino acid compound.
<12> The etching solution according to <11>, wherein the amino acid compound is an aliphatic amino acid or a salt thereof.
<13> The etching solution according to <11>, wherein the amino acid compound is an a-amino acid or a salt thereof.
<14> The etching solution according to any one of <6> to <13>, wherein the nitrogen-containing heteroaromatic compound is an azole compound.
<15> The etching solution according to <14>, wherein the azole compound is a triazole compound.
<16>A method of manufacturing the metal member according to any one of <1> to <5>, the method comprising roughening at least a portion of a surface of the metal member.
<17> The manufacturing method for the metal member according to claim 16, wherein the roughening is performed by etching at least a portion of the surface with the etching solution according to any one of <6> to <15>.
<18>A metal-resin complex, comprising the metal member according to any one of <1>to <5>, and a resin member that is joined to at least a portion of a surface of the metal member.
<19> The metal-resin complex according to <18>, wherein the resin member comprises a thermoplastic resin.
<20> The metal-resin complex according to <19>, wherein the thermoplastic resin comprises at least one selected from the group consisting of polyolefin resin, polyvinyl chloride, polyvinylidene chloride, polystyrene resin, AS resin, ABS resin, polyester resin, poly (meth) acrylic resin, polyvinyl alcohol, polycarbonate resin, polyamide resin, polyimide resin, polyether resin, polyacetal resin, fluorine resin, polysulfone resin, polyphenylene sulfide resin and polyketone resin.
<21>A manufacturing method for a metal-resin complex, the method comprising: disposing the metal member according to any one of <1> to <5>at a mold; and supplying a melted or softened resin to the mold.

### Effect of the Invention

According to an embodiment of the present disclosure, a metal member that exhibits excellent joining strength with respect to a resin member is provided.

According to another embodiment of the present disclosure, a manufacturing method for the metal member is provided.

According to another embodiment of the present disclosure, an etching solution used for the manufacture of the metal member is provided.

According to another embodiment of the present disclosure, a metal-resin complex in which a resin member is joined to the metal member is provided.

According to another embodiment of the present disclosure, a manufacturing method for the metal-resin complex is provided.

### BRIEF DESCRIPTION OF THE DRAWINGS

FIG. 1 is a schematic sectional view illustrating an example of a metal-resin complex.

FIG. 2 is a schematic view illustrating a specimen used for the evaluation of airtightness.

FIG. 3 is a schematic view illustrating a section in a diagonal direction of the specimen used for the evaluation of airtightness.

### EMBODIMENTS FOR IMPLEMENTING THE INVENTION

In the present disclosure, any numerical range described using the expression “from * to” represents a range in which numerical values described before and after the “to” are included in the range as a minimum value and a maximum value, respectively.

In a numerical range described in stages, in the present disclosure, an upper limit value or a lower limit value described in one numerical range may be replaced with an upper limit value or a lower limit value in another numerical range described in stages. Further, in a numerical range described in the present disclosure, the upper limit value or the lower limit value in the numerical range may be replaced with a value shown in the Examples.

In the present disclosure, in a case in which each component in a composition includes plural kinds of substances, the content of each component refers to the total content of the plural kinds of substances present in the composition, unless otherwise specified.

In the present disclosure, the definition of the term “step” includes not only an independent step which is distinguishable from another step, but also a step which is not clearly distinguishable from another step, as long as the purpose of the step is achieved.

<Metal member>

The metal member according to the present disclosure has a surface in which values of L, a and b in CIE 1976 (L*a*b*) color space satisfy at least one of the following Formula (1) or Formula (2):

b≥16 (1): or

L≥2.336×a-2.0536 (2).

The metal member exhibits excellent joining strength with respect to a resin member.

The projected mechanism by which the metal member according to the present disclosure improves the joining strength with respect to a resin member is thought to be as follows.

The values of L, a and b at a surface of the metal member, which relate to reflected light at the surface, reflect a degree of surface roughness. It is thought that a surface of the metal member at which the values of L, a and b satisfy at least one of Formula (1) or Formula (2) has a fine structure in which a degree of roughness is regulated appropriately, and that the fine structure is suitable for increasing the joining strength with respect to a resin member.

Although the projected mechanism has been explained above, the scope of the present disclosure is not limited in any way by the projected mechanism as described above.

The upper limit of b is not limited and may be, for example, 28.

The metal member preferably has a surface in which the values of L and a in CIE 1976 (L*a*b*) color space satisfy Formula (2), and further satisfy the following Formula (3). When the metal member satisfies Formula (2) and Formula (3), it is possible to suppress leakage of a fluid from a junction between the metal member and a resin layer more easily.

L≤2.336×a+14.649 (3)

It is thought that, because the surface roughness is more appropriately controlled, the metal member that satisfies Formula (2) and Formula (3) is suitable for suppressing leakage of a fluid, in addition to improving the joining strength with respect to a resin member.

Although the projected mechanism has been explained above, the scope of the present disclosure is not limited in any way by the projected mechanism as described above.

The metal member preferably has a surface in which the value of a in CIE 1976 (L*a*b*) color space satisfies the following Formula (4). When the metal member satisfies Formula (4), it is possible to suppress leakage of a fluid more easily.

25≥a≥10) (4)

The values of L, a and b are measured with a spectroscopic chronometer. For example, a spectroscopic chronometer manufactured by Nippon Denshoku Industries Co., Ltd. with a trade name of NF 333 may be used for the measurement.

The type of the metal included in the metal member is not particularly limited. Specific examples of the metal include aluminum, iron, copper, nickel, gold, silver, platinum, cobalt, zinc, lead, tin, zirconium, titanium, niobium, chromium, aluminum, magnesium, manganese, and alloys including these metals. Moreover, examples of the metal member include plated materials obtained by subjecting base materials of the aforementioned metals and the aforementioned alloys to plating.

Examples of the alloy include brass, phosphor bronze and steel (for example, stainless steel). Examples of the plated member (i.e., members obtained by subjecting base materials of the aforementioned metals and the aforementioned alloys to plating) include plated steel. Examples of the material for a plating layer include zinc, nickel and chromium.

Among the metals as mentioned above, the metal member preferably includes at least one of copper or copper alloy.

The shape of the metal member is not particularly limited, and examples thereof include a flat panel, a disk, a bent plate, a rod, a cylinder and a lump. The configuration of a surface of the metal member is not particularly limited, and may be flat, curved or the like.

The thickness of the metal member is not particularly limited, and may be from 1 mm to 20 mm, for example. For example, when the metal member is used for cooling units, bus-bar or the like, the thickness of the metal member may be from 1 mm to 5 mm. When the metal member is used for cooling units for automobiles, the thickness of the metal member may be from 1 mm to 5 mm.

### <Metal-Resin Complex>

The metal-resin complex according to the present disclosure includes the metal member according to the present disclosure, and a resin member that is joined to at least a portion of a surface of the metal member.

[Resin Member]

The resin included in the resin member is not particularly limited, and may be selected depending on the purposes of the metal member, and the like.

Examples of the resin include thermoplastic resins (including elastomers) such as polyolefin resin (for example, polypropylene), polyvinyl chloride, polyvinylidene chloride, polystyrene resin, AS resin, ABS resin, polyester resin (for example, poly buty lene terephthalate), poly (meth) acrylic resin, polyvinyl alcohol, polycarbonate resin, polyamide resin, polyimide resin, polyether resin, polyacetal resin, fluorine resin, polysulfone resin, polyphenylene sulfide resin and polyketone resin; and thermosetting resins such as phenol resin, melamine resin, urea resin, polyurethane resin, epoxy resin and unsaturated polyester resin.

The resin may be used singly, or in combination of two or more kinds.

From the viewpoint of moldability, the resin included in the resin member is preferably a thermoplastic resin.

The resin included in the resin member may include an additive of various kinds. Examples of the additive include a filler, a thermostabilizer, an antioxidant, a pigment, a weathering stabilizer, a fire retardant, a plasticizer, a dispersant, a lubricant, a mold-release agent, and an antistatic agent.

The resin member may include a filler. Examples of the filler include glass fiber, carbon fiber, carbon particles, clay, talc, silica, minerals and cellulose fiber. The filler may be used singly, or in combination of two or more kinds.

[Configuration]

The configuration of the metal-resin complex is not particularly limited as long as it includes a metal member and a resin member that is joined to at least a portion of a surface of the metal member, and may be designed depending on the purposes or the like of the metal-resin complex.

For example, the metal-resin complex may include plural metal members: or may include two or more metal members including a single kind of metal or two or more different kinds of metals.

For example, the metal-resin complex may include plural resin members: or may include two or more resin members including a single kind of resin or two or more different kinds of resins.

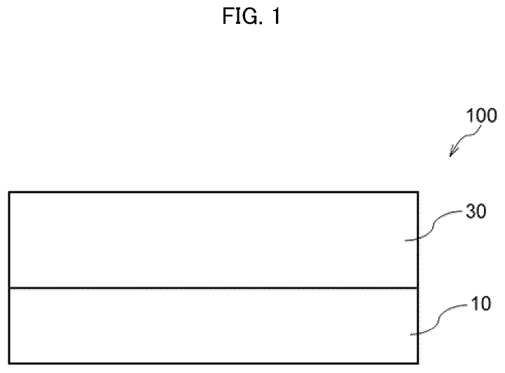

For example, as shown in FIG. 1, the metal-resin complex 100 may include a metal member 10 and a resin member 30 that is disposed on the metal member 10.

The metal-resin complex may be used for various purposes. Examples of the purposes for the metal-resin complex include cooling units, bus-bars, cooling component for vehicles, structural component for vehicles, on-board components for vehicles, casing for electronic components, casing for home appliances, building components, structural components, components for machines, components for automotives, components for electronic devices, household articles such as furniture or kitchen equipment, medical equipment, component for building materials, component for other purposes, and exterior components.

<Etching Solution>

An etching solution according to the present disclosure as described below may be suitably used for obtaining the metal member according to the present disclosure, for example.

The etching solution according to the present disclosure includes an amine compound, a nitrogen-containing heteroaromatic compound, a hydrogen peroxide, and an inorganic acid.

[Amine Compound]

The amine compound functions as a complexing agent that causes a metal to dissolve as a metal complex.

The amine compound is not particularly limited, and may be an alkanolamine compound, a hydroxy lamine compound, an amino acid compound, or the like.

Examples of the alkanolamine compound include a mono-alkanolamine compound, a di-alkanolamine compound, and a tri-alkanolamine compound.

Examples of the mono-alkanolamine compound include monoethanolamine, 2-methylaminoethanol, 2-ethylaminoethanol, 2-(2-aminoethoxy) ethanol, 1-amino-2-propanol, monopropanolamine, dimethylaminoethanol, and a salt of these compounds.

Examples of the di-alkanolamine compound include diethanolamine, N-methyldiethanolamine, dibutanolamine, and a salt of these compounds.

Examples of the tri-alkanolamine compound include triisopropanolamine, triethanolamine, and a salt of these compounds.

Examples of the hydroxylamine include hydroxylamine, N-methyl hydroxylamine, N,N-dimethylhydroxylamine, N, N-diethylhydroxylamine, hydroxy lamine sulfate, and hydroxylamine hydrochloride.

The amine compound may be used singly or in combination of two or more kinds.

From the viewpoint of etching properties, the content of the amine compound with respect to a total mass of the etching solution is preferably from 0.0001% by mass to 5% by mass, more preferably from 0.01% by mass to 0.5% by mass, further preferably from 0.01% by mass to 0.3% by mass, particularly preferably from 0.01% by mass to 0.1% by mass.

From the viewpoint of suppressing a leakage of a fluid more easily, the amine compound is preferably an amino acid compound.

[Amino Acid Compound]

An amino acid compound functions as a complexing agent that causes a metal to dissolve as a metal complex. Since an amino acid compound is highly adsorptive with respect to a metal, the amino acid compound suitably serves the function as a complexing agent.

Further, an amino acid compound has an ability to reduce an effect of a concentration of hydrogen peroxide, which serves as an oxidant, on a rate of etching. Specifically, decomposition of hydrogen peroxide with time may decrease the concentration of hydrogen peroxide in the etching solution and a rate of etching may be lowered. Therefore, an amino acid compound may reduce an effect of lowering a rate of etching due to the decomposition of hydrogen peroxide.

Further, since an amino acid compound has a pH buffer action, an amino acid compound may suppress the variation in pH of the etching solution and stabilize the pH of the etching solution.

In the present disclosure, the “amino acid compound” refers to an amino acid and a salt thereof. The amino acid refers to an organic compound having both an amino group and a carboxy group.

The amino acid compound is not particularly limited, and examples thereof include alanine, glutamic acid, glycine, leucine, isoleucine, proline, serine, threonine, valine, β-alanine, y-alanine, arginine, asparagine, asparagine acid, cysteine, glutamine, histidine, lycine, methionine, triptophan, tyrosine, ornithine, phenylalanine, 4-chlorophenylalanine, 4-bromophenylalanine, 4-nitrophenylalanine, 3-(3,4-dihydrophenyl) alanine, α-methylphenylalanine, and a salt of these compounds. Examples of the salt of an amino acid compound include an alkali metal salt and an ammonium salt.

From the viewpoint of etching properties, the amino acid compound is preferably an aliphatic amino acid or a salt thereof.

From the viewpoint of etching properties, the amino acid compound is preferably an a-amino acid or a salt thereof.

A single kind of the amino acid compound may be used alone, or two or more kinds thereof may be used in combination.

From the viewpoint of etching properties, the content of the amino acid compound with respect to a total mass of the etching solution is preferably from 0.0001% by mass to 5% by mass, more preferably from 0.01% by mass to 0.5% by mass, further preferably from 0.01% by mass to 0.3% by mass, particularly preferably from 0.01% by mass to 0.1% by mass.

[Nitrogen-Containing Heteroaromatic Compound]

The nitrogen-containing heteroaromatic compound functions to suppress rapid etching of a metal, and serves suitably to the adjustment of roughness at a surface of a metal.

In the present disclosure, the “nitrogen-containing heteroaromatic compound” refers to a compound having a hetero ring that contains nitrogen.

The nitrogen-containing heteroaromatic compound is not particularly limited, and examples thereof include compounds with a 5-membered ring, such as pyrrole compounds, pyrazole compounds, imidazole compounds, triazole compounds, and derivatives of these compounds: compounds with a 6-membered ring, such as pyridine compounds, pyridazine compounds, pyrazine compounds, pyrimidine compounds, triazine compounds, and derivatives of these compounds; and compounds with multiple rings, such as indole, purine, quinoline, isoquinoline, quinoxaline, cinnoline, quinazoline, phthalazine, naphthyridine, pteridin, acridine, naphthazine, phenazine, phenanthroline, and derivatives of these compounds.

From the viewpoint of etching properties, the nitrogen-containing heteroaromatic compounds is preferably an azole compound.

The azole compound is not particularly limited, and examples thereof include triazole compounds such as 1,2,3-triazole, 1,2,4-triazole, 5-phenyl-1,2,4-triazole, 5-amino-1,2,4-triazole, 1H-benzotriazole, 1-methyl-benzotriazole, 5-methyl-1H-benzotriazole and 3-amino-1H-triazole: tetrazole compounds such as 1H-tetrazole, 5-methyl-1H-tetrazole, 5-phenyl-1H-tetrazole and 5-amino-1H-tetrazole: imidazole compounds such as 1H-imidzole and 1H-benzoimidazole; and thiazole compounds such as 1,3-thiazole and 4-methylthiazole.

From the viewpoint of etching properties, the azole compound is preferably a triazole compound.

A single kind of the nitrogen-containing heteroaromatic compound may be used alone, or two or more kinds thereof may be used in combination.

From the viewpoint of readily securing the joining strength and airtightness, the content of the nitrogen-containing heteroaromatic compound with respect to a total mass of the etching solution is preferably from 0.01% by mass to 2.0% by mass, more preferably from 0.8% by mass to 1.5% by mass.

[Hydrogen Peroxide]

The hydrogen peroxide functions as an oxidant that causes oxidation of a metal.

From the viewpoint of etching properties, the content of the hydrogen peroxide with respect to a total mass of the etching solution is preferably from 0.5% by mass to 7% by mass, more preferably from 1.3% by mass to 3.0% by mass.

[Inorganic Acid]

The inorganic acid is used to dissolve an oxidized metal.

The inorganic acid is not particularly limited, and examples thereof include sulfuric acid, nitric acid, hydrochloric acid, phosphoric acid, hypophosphorous acid, carbonic acid, sulfamic acid, boric acid and hydofluoric acid.

From the viewpoint of environmental burdens, the inorganic acid is preferably inorganic acid other than hydrochloric acid, phosphoric acid or hydrofluoric acid.

From the viewpoint of achieving a high rate of dissolving copper and from the viewpoint of economy, the inorganic acid is preferably sulfuric acid.

A single kind of the inorganic acid may be used alone, or two or more kinds thereof may be used in combination.

From the viewpoint of etching properties, the content of the inorganic acid with respect to a total mass of the etching solution is preferably from 5% by mass to 20% by mass, more preferably from 5% by mass to 15% by mass, further preferably from 6% by mass to 13% by mass, particularly preferably from 8% by mass to 12% by mass.

[Other Components]

The etching solution may include water, in addition to an amino acid compound, a nitrogen-containing heteroaromatic compound, a hydrogen peroxide and an inorganic acid.

Water is preferably subjected to a treatment to remove impurities such as metal ions or organic compounds, particles, or the like. Examples of the treatment include distillation, ion-exchange treatment, filtering, and adsorption treatment of various kinds. Water is preferably pure water or ultrapure water.

The etching solution may include a halide ion source that generates fluoride ions, chloride ions, bromide ions or the like, in order to increase a degree of roughness in the irregularities. Typically, chloride ions are preferred as the halide ions.

Examples of the halide ion source include alkali metal salts such as sodium chloride, ammonium chloride and potassium chloride: oxohalides such as sodium chlorate and potassium chlorate; and copper chloride.

A single kind of the halide ion source may be used alone, or two or more kinds thereof may be used in combination.

When the etching solution includes a halide ion source, the content thereof may be from 0.0001% by mass to 0.05% by mass with respect to a total mass of the etching solution, from the viewpoint of etching properties.

The etching solution may include, as a solvent other than water, an aqueous organic solvent such as alcohols, glycols or ethers, in order to adjust the etching properties.

A single kind of the aqueous organic solution may be used alone, or two or more kinds thereof may be used in combination.

When the etching solution includes an aqueous organic solution, the content thereof may be approximately from 0.1% by mass to 20% by mass with respect to a total mass of the etching solution, from the viewpoint of etching properties.

The etching solution may include an organic acid other than amino acid compounds in order to adjust the etching properties. Examples of the organic acid other than amino acid compounds include aliphatic carboxylic acid and aromatic carboxylic acid.

A single kind of the organic acid may be used alone, or two or more kinds thereof may be used in combination.

When the etching solution includes an organic acid, the content thereof may be approximately from 1% by mass to 15% by mass with respect to a total mass of the etching solution.

The etching solution may include an additive typically used for an etching solution, other than the components as described above.

Examples of the additive include a stabilizer, a solubilizer, an antifoamer, a pH adjuster, a specific gravity adjuster, a viscosity adjuster, a wettability adjuster, a chelating agent, an oxidant, a reductant, and a surfactant.

A single kind of the additive may be used alone, or two or more kinds thereof may be used in combination.

When the etching solution includes an additive, the content thereof may be approximately from 0.001% by mass to 10% by mass with respect to a total mass of the etching solution.

[pH]

From the viewpoint of etching properties, the pH at 25° C. of the etching solution is preferably 3.0 or less, more preferably 1.0 or less. The pH is measured with a pH meter.

The metal to be etched with the etching solution is not particularly limited. For example, the etching solution may be used for the etching of the metal in connection with the metal member as described above.

The method for producing the etching solution is not particularly limited. For example, the etching solution may be produced by mixing the components as described above, and stirring the mixture as necessary.

<Manufacturing Method for Metal Member>

The method for manufacturing the metal member according to the present disclosure is not particularly limited. The metal member may be suitably manufactured by the manufacturing method according to the present disclosure as explained below.

The manufacturing method for a metal member according to the present disclosure includes a process of roughening at least a portion of a surface of a metal member (hereinafter, also referred to as a “roughening process”).

The manufacturing method for a metal member may include a pretreatment process prior to the roughening process, or may include an aftertreatment process after the roughening process.

In the following, the manufacturing method for a metal member is described in detail by referring to an embodiment of the method in which a pretreatment process, a roughening process and an aftertreatment process are performed in this order.

[Pretreatment process]

A pretreatment process is performed for removing a film disposed at a surface of the metal member, such as a film formed of oxides, hydroxides or the like. The pretreatment process is typically performed by way of mechanical polishing or chemical polishing. When a surface of the metal member to be joined to a resin member has a significant degree of contamination such as machine oil, a degreasing process may be performed prior to the pretreatment process using an alkali aqueous solution, such as an aqueous solution of sodium hydroxide or potassium hydroxide. [Roughening process]

The method for performing roughening to at least a portion of a surface of the metal member is not particularly limited, and examples thereof include chemical treatment and mechanical treatment. Examples of the mechanical treatment include sand blasting, knurling and laser processing. Examples of the chemical treatment include etching using an alkali etchant or an acid etchant.

A single kind of treatment may be performed alone, or two or more kinds thereof may be performed in combination. Among the methods for treatment, etching with an acid etchant is preferred.

The etching solution according to the present disclosure may be suitable used as an acid etchant. In this embodiment, the roughing process corresponds to a process of etching at least a portion of a surface of the metal member with the etching solution according to the present

### DISCLOSURE

Examples of the method for contacting a metal member with an etching solution include a dip method in which a metal member is dipped in an etching solution: a spray method in which a metal member is sprayed with an etching solution; and a spin method in which an etching solution is ejected toward a metal member while spinning the same.

The temperature of the etching solution may be adjusted as appropriate in view of the type of a metal member, composition of an etching solution, or the like. For example, the temperature of the etching solution is preferably from 30° C. to 60° C., more preferably from 35° C. to 45° C.

The treatment time (i.e., the time period in which a metal member is in contact with an etching solution) may be adjusted as appropriate in view of the type of a metal member, composition of an etching solution, or the like. For example, the treatment time is preferably from 60 seconds to 480 seconds, more preferably from 150 seconds to 300 seconds.

The pH of an etching solution may vary due to the etching. Therefore, the pH of an etching solution may be adjusted during performing the etching, as necessary.

[Aftertreatment Process]

The metal member is washed after performing the roughening process. The aftertreatment process typically includes water washing and drying. The aftertreatment process may include ultra-sonic washing for the purpose of desmutting.

When a metal member is prepared by performing etching with the etching solution according to the present disclosure, a nitrogen-containing heteroaromatic compound included in the etching solution may remain at a surface of the metal member. In other words, a nitrogen-containing heteroaromatic compound may exist at at least a portion of a surface (or at an entire surface). When a metal-resin complex is prepared using a metal member as mentioned above, a nitrogen-containing heteroaromatic compound may exist at at least a portion of a joint interface (or at an entire joint interface) between the metal member and the resin member.

<Manufacturing Method for Metal-Resin Complex>

The method for manufacturing the metal-resin complex according to the present disclosure is not particularly limited. The metal-resin complex is suitably manufactured by the method for a metal-resin complex according to the present disclosure as described below.

The manufacturing method for a metal-resin complex according to the present disclosure includes:
disposing the metal member according to the present disclosure at a mold (hereinafter, also referred to as a “mold-disposition process”); and
supplying a melted or softened resin to the mold (hereinafter, also referred to as a “resin-supply process”).

In the mold-disposition process, a metal member is disposed at a mold. In the resin-supply process, a melted or softened resin is supplied to the mold.

The melted resin, which has been supplied to the mold, solidifies while being in contact with at least a portion of a roughened surface of the metal member (i.e., a surface satisfying Formula (1)).

The details and preferred embodiments of the resin are the same as the details and preferred embodiments of the resin included in the resin member of the metal-resin complex as described above.

Other conditions for the manufacture method may be determined as appropriate depending on known conditions.

### EXAMPLES

In the following, the present disclosure is explained in detail by referring to the Examples. However, the present disclosure is not limited to the Examples.

### Example 1

A metal material for manufacturing a metal member was prepared by cutting a copper alloy plate of Alloy No. C1100 according to JIS H 3100:2012 (thickness: 2 mm) into a size of 45 mm in length and 18 mm in width.

[Pretreatment Process]

The metal material was subjected to degreasing by dipping the metal material in an aqueous sodium hydroxide of 2.6% by mass, containing 0.16% by mass of gluconic acid sodium salt (55° C.), for 5 minutes while performing ultra-sonic washing, and then washing three times (20 seconds for each washing).

Subsequently, a coating at a surface of the metal material was removed by dipping the metal material in an aqueous sodium hydroxide of 0.002% by mass, containing 0.1% by mass of benzotriazole and 0.3% by mass of 2-isopropoxyethanol (35° C.), for 20 seconds, and then washing three times (20 seconds for each washing).

[Roughening Process]

An etching solution was prepared by dissolving, in water, 9.5% by mass of sulfuric acid, 2% by mass of hydrogen peroxide, 1.1% by mass of benzotriazole, 0.024% by mass of glycine and 0.00225% by mass of sodium chloride

The metal material was dipped in the etching solution (40° C.) for 3 minutes and washed with water three times (20 seconds for each washing), whereby a fine structure was formed at a surface of the metal material. The pH of the etching solution at 25° C. measured with a pH meter (D-71, manufactured by Horiba, Ltd.) was 0.3.

[Aftertreatment Process]

The metal material was dipped in water (room temperature) for 3 minutes while performing ultra-sonic washing for desmutting. The metal material was dried at 80° C. for 20 minutes.

The metal member of Example 1 was manufactured by the processes as described above.

(Measurement of values of L, a and b)

The values of L, a and b at a surface of the metal member was measured with a spectroscopic chronometer (NF 333, manufactured by Nippon Denshoku Industries Co., Ltd.)

[Preparation of metal-resin complex]

The metal member was disposed at a small-size dumbbell metal-insert mold, attached to an injection machine (J55-AD, the Japan Steel Works, Ltd.) Subsequently, polyphenylenesulfide (PPS, SUSTEEL BGX 545, Tosoh Corporation) was supplied to the mold by injection molding at a mold temperature of 150° C., thereby preparing a metal-resin complex in which a resin member is formed on the metal member. The area of a joint interface between the metal member and the resin member was 10 mm×50 mm.

(Measurement of Joining Strength)

The shear joining strength (MPa) of the metal-resin complex was measured by a method according to ISO 19095.

Specifically, a breaking load (N) was measured with a tensile tester (Model 1323, Aikoh Engineering Co., Ltd.) with a special attachment at room temperature (23° C.), under the conditions of a chuck distance of 60 mm and a tensile rate of 10 mm/min.

The shear joining strength (MPa) was calculated by dividing the breaking load (N) by the area of a joint interface between the metal member and the resin member (50 mm2).

When the metal-resin complex has a shear joining strength of 15 MPa or more, the metal-resin complex was regarded as having excellent joining strength. The result is shown in Table 1.

(Evaluation of Helium Leakage)

A rate of helium leakage of the metal-resin complex was measured for the evaluation of airtightness. The measurement was performed with a helium leak detector (M-212 LD, Canon Anelva Corporation).

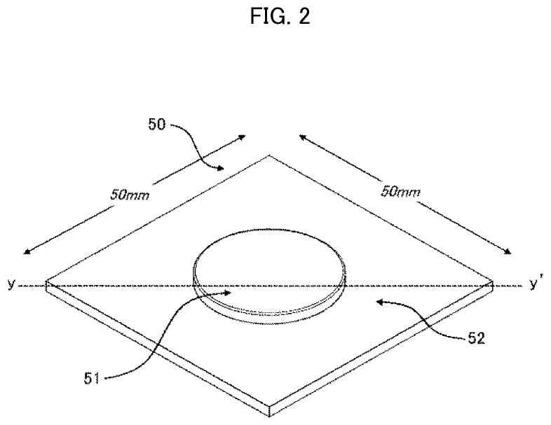

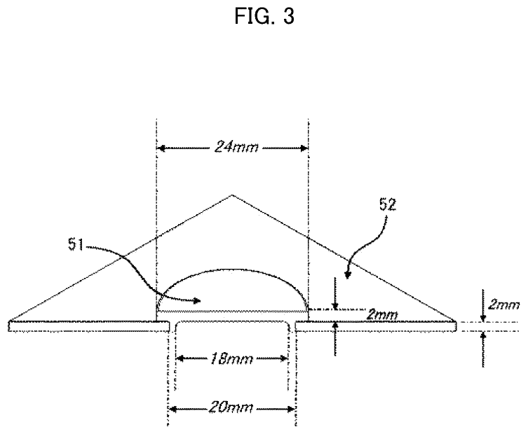

FIG. 2 illustrates a configuration of a specimen used for the evaluation of airtightness according to ISO 19095-2 (Type D. 2.2 specimen) and FIG. 3 illustrates a sectional view of the specimen in a diagonal direction. The specimen has a hole with a diameter of 20 mm formed at a rectangular metal plate (50 mm× 50 mm× 2 mm), and a resin member is attached to a circumference of the hole by injecting a light-absorbing material (see FIG. 3).

A portion at a periphery of a surface of the metal portion of the specimen was not etched in order to secure the airtightness of an O-ring (packing) to be disposed between the attachment of the helium leak detector (test port flange face) and the specimen. The portion was covered with a masking tape (No. 854, 3M Japan Limited) so as not to be etched.

A specimen in which helium leakage was not observed within 1 minute during the application of helium gas (0.1 MPa), i.e., a specimen with an increase in the amount of helium leakage of within 10%, as compared with the amount of helium leakage in a blank sample within 1 minutes during the application of helium gas (5.5×10-7 P a·m3/sec), was categorized as P (showing favorable results in the helium leakage test) in Table 1.

A specimen in which helium leakage is observed, i.e., a specimen with an increase in the amount of helium leakage of greater than 10%, as compared with the amount of helium leakage in a blank sample within 1 minutes during the application of helium gas, was categorized as F in Table 1.

### Examples 2 to 23

The metal member and the metal-resin complex were prepared in the same manner as Example 1, except that the composition of an etching solution, the resin type, the solution temperature and the treatment time were changed as described in Tables 1 to 4.

In Table 4, PP refers to polypropylene (Prime Polypro V7100, Prime Polymer Co., Ltd.), PA6 refers to polyamide 6 (Amilan CM1011G-30, Toray Industries, Inc.) and PBT refers to polybutylene terephthalate (Duranex 930HL, Polyplastics Co., Ltd.)

The metal member and the metal-resin complex obtained in Examples 2 to 23 were subjected to the measurement of values of L, a and b, the measurement of a joining strength, and the evaluation of a helium leakage. The results are shown in Table 1 to 4.

TABLE 1

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Etching | Sulfuric acid | 9.5 | 9.5 | 8 | 8 | 11.4 | 11.4 | 18 | 5 |
| solution | Hydrogen peroxide | 2 | 2 | 1.5 | 1.5 | 2.4 | 2.4 | 4 | 2 |
| composition | Benzotriazole | 1.1 | 1.1 | 0.88 | 0.88 | 1.32 | 1.32 | 2.2 | 1.1 |
| [% by mass] | Sodium chloride | 0.00225 | 0.00225 | 0.00225 | 0.00225 | 0.00225 | 0.00225 | 0.0045 | 0.00225 |
| | Glycine | 0.024 | 0.024 | 0.024 | 0.024 | 0.024 | 0.024 | 0.048 | 0.024 |

| | | | | | | | | |
|---|---|---|---|---|---|---|---|---|
| pH | 0.3 | 0.3 | 0.5-1.0 | 0.5-1.0 | 0.1 or less | 0.1 or less | 0.1 or less | 0.5-1.0 |
| Liquid temperature [° C.] | 40 | 40 | 35 | 35 | 45 | 45 | 40 | 40 |
| Treatment time [min] | 3 | 4 | 3 | 5 | 3 | 2 | 1 | 3 |
| Resin for joining | PPS | PPS | PPS | PPS | PPS | PPS | PPS | PPS |
| Shear joining strength [Mpa] | 44 | 44 | 45 | 44 | 45 | 45 | 48 | 21.9 |
| Helium leakage | P | P | P | P | P | P | P | F |
| L | 53.2 | 55.8 | 53.8 | 54.9 | 58.7 | 59 | 52.7 | 63.3 |
| a | 18 | 18.8 | 18 | 19.5 | 19.8 | 19.7 | 19.7 | 19.1 |
| b | 19.3 | 20.1 | 19.2 | 19.8 | 20 | 19.8 | 17.5 | 21.5 |
| Formula (1) sufficiency | Satisfied | Satisfied | Satisfied | Satisfied | Satisfied | Satisfied | Satisfied | Satisfied |
| Formula (2) sufficiency | Satisfied | Satisfied | Satisfied | Satisfied | Satisfied | Satisfied | Satisfied | Satisfied |
| Formula (3) sufficiency | Satisfied | Satisfied | Satisfied | Satisfied | Satisfied | Satisfied | Satisfied | Not satisfied |
| Formula (4) sufficiency | Satisfied | Satisfied | Satisfied | Satisfied | Satisfied | Satisfied | Satisfied | Satisfied |

TABLE 2

| | | Exam- | Exam- | Exam- | Exam- | Exam- | Exam- | Exam- |
|---|---|---|---|---|---|---|---|---|
| | | ple 9 | ple 10 | ple 11 | ple 12 | ple 13 | ple 14 | ple 15 |
| Etching | Sulfuric acid | 9.5 | 9.5 | 8 | 8 | 11.4 | 9.5 | 9.5 |
| solution | Hydrogen peroxide | 2 | 2 | 1.5 | 1.5 | 2.4 | 2 | 2 |
| composition | Benzotriazole | 1.1 | 1.1 | 0.88 | 0.88 | 1.32 | 1.1 | 1.1 |
| [% by mass] | Sodium chloride | 0.00225 | 0.00225 | 0.00225 | 0.00225 | 0.00225 | 0.00225 | 0.00225 |
| | Glycine | 0.024 | 0.024 | 0.024 | 0.024 | 0.024 | 0.24 | 0.5 |

| | | | | | | | |
|---|---|---|---|---|---|---|---|
| pH | 0.3 | 0.3 | 0.5-1.0 | 0.5-1.0 | 0.1 or less | 0.3 | 0.3 |
| Liquid temperature [° C.] | 40 | 40 | 35 | 35 | 45 | 40 | 40 |
| Treatment time [min] | 1 | 2 | 1 | 2 | 1 | 3 | 3 |
| Resin for joining | PPS | PPS | PPS | PPS | PPS | PPS | PPS |
| Shear joining strength [Mpa] | 38 | 40 | 41 | 45 | 35 | 41 | 41 |
| Helium leakage | F | F | F | F | F | P | P |
| L | 58.9 | 58.4 | 51.6 | 54.8 | 58.8 | 55.4 | 52.4 |
| a | 16.4 | 17.8 | 15.2 | 16.5 | 17.1 | 19.3 | 20.1 |
| b | 20 | 19 | 18.1 | 18.8 | 19.5 | 19.2 | 19.7 |
| Formula (1) sufficiency | Satisfied | Satisfied | Satisfied | Satisfied | Satisfied | Satisfied | Satisfied |
| Formula (2) sufficiency | Satisfied | Satisfied | Satisfied | Satisfied | Satisfied | Satisfied | Satisfied |
| Formula (3) sufficiency | Not satisfied | Not satisfied | Not satisfied | Not satisfied | Not satisfied | Satisfied | Satisfied |
| Formula (4) sufficiency | Satisfied | Satisfied | Satisfied | Satisfied | Satisfied | Satisfied | Satisfied |

TABLE 3

| | | Exam- | Exam- | Exam- | Exam- | Exam- |
|---|---|---|---|---|---|---|
| | | ple 16 | ple 17 | ple 18 | ple 19 | ple 20 |
| Etching | Sulfuric acid | 9.5 | 9.5 | 9.5 | 9.5 | 9.5 |
| solution | Hydrogen peroxide | 2 | 2 | 2 | 2 | 2 |
| composition | Benzotriazole | 1.1 | 1.1 | 1.1 | 1.1 | — |
| [% by mass] | 3-methyl-1H-benzotriazole | — | — | — | — | 0.8 |
| | Sodium chloride | 0.00225 | 0.00225 | 0.00225 | 0.00225 | 0.00225 |
| | Glycine | — | — | — | — | 0.024 |
| | Alanine | 0.24 | — | — | — | — |
| | Arginine | — | 0.24 | — | — | — |
| | Triethanolamine | — | — | 0.24 | — | — |
| | Hydroxylamine sulfate | — | — | — | 0.24 | — |

| | | | | | |
|---|---|---|---|---|---|
| pH | 0.3 | 0.3 | 0.3 | 0.3 | 0.3 |
| Liquid temperature [° C.] | 40 | 40 | 40 | 40 | 40 |
| Treatment time [min] | 3 | 3 | 3 | 3 | 2.5 |
| Resin for joining | PPS | PPS | PPS | PPS | PPS |
| Shear joining strength [Mpa] | 41 | 41 | 41 | 41 | 46 |
| Helium leakage | P | P | F | F | P |
| L | 54.8 | 55.6 | 54 | 52.7 | 45.3 |
| a | 20.6 | 20.2 | 18.4 | 17.5 | 16.2 |
| b | 19.9 | 19.8 | 18.7 | 18.5 | 17.9 |
| Formula (1) sufficiency | Satisfied | Satisfied | Satisfied | Satisfied | Satisfied |
| Formula (2) sufficiency | Satisfied | Satisfied | Satisfied | Satisfied | Satisfied |
| Formula (3) sufficiency | Satisfied | Satisfied | Satisfied | Satisfied | Satisfied |
| Formula (4) sufficiency | Satisfied | Satisfied | Satisfied | Satisfied | Satisfied |

TABLE 4

| | | Example | Example | Example |
|---|---|---|---|---|
| | | 21 | 22 | 23 |
| Etching | Sulfuric acid | 9.5 | 9.5 | 9.5 |
| solution | Hydrogen peroxide | 2 | 2 | 2 |
| composition | Benzotriazole | 1.1 | 1.1 | 1.1 |
| [% by mass] | Sodium chloride | 0.00225 | 0.00225 | 0.00225 |
| | Glycine | 0.024 | 0.024 | 0.024 |

| | | | |
|---|---|---|---|
| pH | 0.3 | 0.3 | 0.3 |
| Liquid temperature [° C.] | 40 | 40 | 40 |
| Treatment time [min] | 3 | 3 | 3 |
| Resin for joining | PP | PA6 | PBT |
| Shear joining strength [Mpa] | 16 | 56 | 34 |
| Helium leakage | P | P | P |
| L | 52.6 | 52.4 | 53.0 |
| a | 19.0 | 18.9 | 18.9 |
| b | 18.4 | 18.4 | 18.3 |
| Formula (1) sufficiency | Satisfied | Satisfied | Satisfied |
| Formula (2) sufficiency | Satisfied | Satisfied | Satisfied |
| Formula (3) sufficiency | Satisfied | Satisfied | Satisfied |
| Formula (4) sufficiency | Satisfied | Satisfied | Satisfied |

As shown in Table 1 to 4. the metal-resin complexes of Examples 1 to 23. in which the metal member satisfies Formula (1). exhibited an excellent joining strength.

As shown in the comparison of Examples 1 to 17 and Examples 20 to 23, in which an amino acid compound was included in the etching solution as an amine compound, the metal-resin complexes of Examples 1 to 7, 14 to 17 and 20 to 23, obtained by using a metal member that satisfies Formula (2) and Formula (3), exhibited a favorable result in the helium leakage test.

As shown in the comparison of Examples 14 and 16-19, in which the etching solution contains an equal amount of an amine compound, the metal-resin complexes of Examples 14, 16 and 17, obtained by using an etching solution containing an amino acid compound, exhibited a favorable result in the helium leakage test.

### EXPLANATION OF SYMBOLS

10 Metal member
30 Resin member
100 Metal-resin complex

1. A metal member, having a surface in which values of L, a and b in CIE 1976 (L*a*b*) color space satisfy at least one of the following Formula (1) or Formula (2):
b≥16 (1); or
L≥2.336×a-2.0536 (2).

2. The metal member according to claim 1, wherein, in the surface, values of L and a in CIE 1976 (L*a*b*) color space satisfy the Formula (2) and the following Formula (3):
L≤2.336×a+14.649 (3).

3. The metal member according to claim 2, wherein, in the surface, a value of a in CIE 1976 (L*a*b*) color space satisfies the following Formula (4):
25≥a≥10 (4).

4. The metal member according to claim 1, comprising at least one of copper or copper alloy.

5. The metal member according to claim 1, comprising a nitrogen-containing heteroaromatic compound that is disposed at least a portion of the surface.

6. An etching solution, comprising an amine compound, a nitrogen-containing heteroaromatic compound, a hydrogen peroxide, and an inorganic acid.

7. The etching solution according to claim 6, wherein a content of the amine compound with respect to a total mass of the etching solution is from 0.0001% by mass to 5% by mass.

8. The etching solution according to claim 6, wherein a content of the nitrogen-containing heteroaromatic compound with respect to a total mass of the etching solution is from 0.01% by mass to 2.0% by mass.

9. The etching solution according to claim 6, wherein a content of the hydrogen peroxide with respect to a total mass of the etching solution is from 0.5% by mass to 7% by mass.

10. The etching solution according to claim 6, wherein a content of the inorganic acid with respect to a total mass of the etching solution is from 5% by mass to 20% by mass.

11. The etching solution according to claim 6, wherein the amine compound is an amino acid compound.

12. The etching solution according to claim 11, wherein the amino acid compound is an aliphatic amino acid or a salt thereof.

13. The etching solution according to claim 11, wherein the amino acid compound is an α-amino acid or a salt thereof.

14. The etching solution according to claim 6, wherein the nitrogen-containing heteroaromatic compound is an azole compound.

15. The etching solution according to claim 14, wherein the azole compound is a triazole compound.

16. A method of manufacturing the metal member according to claim 1, the method comprising roughening at least a portion of a surface of the metal member.

17. The method of manufacturing the metal member according to claim 16, wherein the roughening is performed by etching at least a portion of the surface with the etching solution, comprising an amine compound, a nitrogen-containing heteroaromatic compound, a hydrogen peroxide, and an inorganic acid.

18. A metal-resin complex, comprising the metal member according to claim 1, and a resin member that is joined to at least a portion of a surface of the metal member.

19. The metal-resin complex according to claim 18, wherein the resin member comprises a thermoplastic resin.

20. The metal-resin complex according to claim 19, wherein the thermoplastic resin comprises at least one selected from the group consisting of polyolefin resin, polyvinyl chloride, polyvinylidene chloride, polystyrene resin, AS resin, ABS resin, polyester resin, poly (meth) acrylic resin, polyvinyl alcohol, polycarbonate resin, polyamide resin, polyimide resin, polyether resin, polyacetal resin, fluorine resin, polysulfone resin, polyphenylene sulfide resin and polyketone resin.

21. A manufacturing method for a metal-resin complex, the method comprising:
disposing the metal member according to claim 1 at a mold; and
supplying a melted or softened resin to the mold.
